(19) United States
(12) Patent Application Publication
(10) Pub. No.: US 2010/0202480 A1
(43) Pub. Date: Aug. 12, 2010

(54) SEMICONDUCTOR LIGHT-EMITTING ELEMENT AND METHOD FOR MANUFACTURING THE SAME

(75) Inventor: Kyosuke Kuramoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MITSUBISHI ELECTRIC CORPORATION, Tokyo (JP)

(21) Appl. No.: 12/499,153

(22) Filed: Jul. 8, 2009

(30) Foreign Application Priority Data
Feb. 10, 2009 (JP) 2009-028406

(51) Int. Cl. H01S 3/00

(52) U.S. Cl. 372/38.05

(57) ABSTRACT

A semiconductor light-emitting element s includes a semiconductor substrate; a semiconductor laminate structure having a first conductivity-type cladding layer, an active layer, a second conductivity-type cladding layer, and a second conductivity-type contact layer sequentially arranged on the semiconductor substrate; a stripe-shaped waveguide region on an upper surface of the semiconductor laminate structure; and recessed portions on the upper surface, spaced from the waveguide region; a first electrode electrically connected to the semiconductor substrate; a second electrode electrically connected to the contact layer; a pad electrode on the second electrode; and an inner recessed portion electrode in the recessed portions, on an insulating film.

### BACKGROUND OF THE INVENTION

1. Field of the Invention

The present invention relates to a semiconductor light-emitting element wherein a waveguide region in a stripe structure is formed, and a method for manufacturing the same, and specifically, to a semiconductor light-emitting element that can sufficiently suppress the ripples of FFP, and a method for manufacturing the same.

2. Background Art

In recent years, semiconductor lasers using a nitride-based III-V group compound semiconductor, such as AlInGaN, have been actively studied and developed as semiconductor lasers that can emit light ranging from blue region to ultraviolet region, which is required for high densification of optical disks, and already have been put to practical use.

Since light radiated from a semiconductor laser is condensed in a small spot on an optical disk through a lens system, the far field pattern (FFP) of laser beams outputted from the end surface is preferably close to a Gaussian shape, and is required not to have disturbance, such as ripples.

In a semiconductor laser, a stripe-shaped waveguide region is formed on the upper surface of the semiconductor laminate structure for narrowing current and confining light. By the waveguide region, light distribution is formed in the shape close to a Gaussian shape, and is reciprocated between the end surfaces of the resonator. At this time, if there is structural incompleteness in the shape of the waveguide region or the thickness of epitaxial structure, the distribution of refractive index differs depending on the location in the resonator direction.

Difference in the refractive index distribution means that the shape of waveguide mode of the light is different. Therefore, when light goes to the portion where the refractive index is different, laser beams are scattered in horizontal and vertical directions from the waveguide region due to the inconsistency of the shape of waveguide mode. When the scattered light is radiated from the front end surface together with the laser beams, ripples occur in FFP. Especially in a semiconductor laser using a nitride-based III-V group compound semiconductor, ripples of FFP in the horizontal direction often occurs to cause practically serious problems.

To solve these problems, a semiconductor light-emitting element having recessed portions formed in the upper surface of the semiconductor laminate structure separated form the waveguide region has been proposed (for example, refer to Japanese Patent Application Laid-Open No. 2005-311308). By these recessed portions, the radiated light scattered in the horizontal direction is made not to be radiated to the exterior to suppress the ripples of FFP.

### SUMMARY OF THE INVENTION

However, by conventional semiconductor light-emitting elements, even if recessed portions were formed, ripples still remained in FFP, and the ripples in FFP could not be sufficiently suppressed.

To solve problems as described above, it is an object of the present invention to provide a semiconductor light-emitting element that can sufficiently suppress the ripples of FFP, and a method for manufacturing such a semiconductor light-emitting element.

According to one aspect of the present invention, a semiconductor light-emitting element comprises: a semiconductor substrate; a semiconductor laminate structure having a first conductivity-type clad layer, an active layer, a second conductivity-type clad layer, and a second conductivity-type contact layer sequentially formed on said semiconductor substrate; a stripe-shaped waveguide region formed on an upper surface of the semiconductor laminate structure; and recessed portions formed on the upper surface separated from said waveguide region; a first conductivity-type electrode electrically connected to said semiconductor substrate; a second conductivity-type electrode electrically connected to said contact layer; a pad electrode formed on said second conductivity-type electrode; and an inner recessed portion electrode formed in said recessed portion via an insulating film.

According to the present invention, the ripples of FFP can be sufficiently suppressed.

Other and further objects, features and advantages of the invention will appear more fully from the following description.

### BRIEF DESCRIPTION OF THE DRAWINGS

FIG. 1 is a perspective view showing a semiconductor light-emitting element according to the first embodiment of the present invention.

FIG. 2 is a sectional view of the semiconductor light-emitting element drawn along line A-A′ shown in FIG. 1.

FIG. 3 is a perspective view showing a semiconductor light-emitting element according to a comparative embodiment.

FIG. 4 is a sectional view of the semiconductor light-emitting element along line B-B′ shown in FIG. 3.

FIG. 5 is a graph showing a result of measurement of a semiconductor light-emitting element wherein no recessed portions are formed in the horizontal direction FFP.

FIG. 6 is a graph showing a result of measurement of a semiconductor light-emitting element in the horizontal direction FFP according to the comparative embodiment.

FIG. 7 is a perspective view showing the semiconductor light-emitting element according the comparative embodiment.

FIG. 8 is a top view showing a semiconductor light-emitting element according to the first embodiment.

FIG. 9 is a graph showing a result of measurement of FFP in the horizontal direction of a semiconductor light-emitting element according to the first embodiment.

FIG. 10 is a perspective view showing a semiconductor light-emitting element according to the second embodiment.

FIG. 11 is a top view showing a semiconductor light-emitting element according to the second embodiment.

FIG. 12 is a top view showing a semiconductor light-emitting element according to the third embodiment.

### DETAILED DESCRIPTION OF THE PREFERRED EMBODIMENTS

### First Embodiment

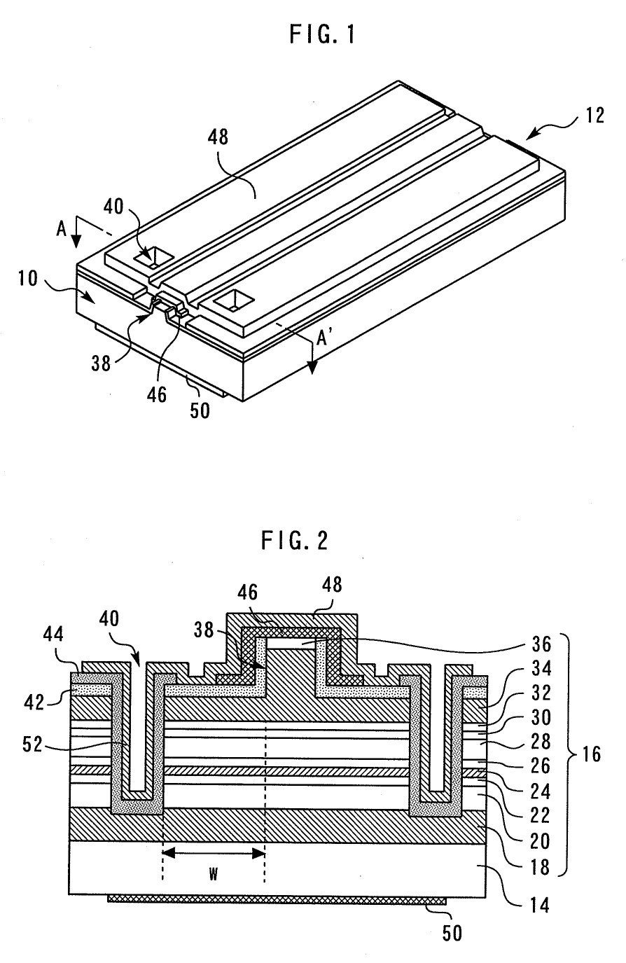

FIG. 1 is a perspective view showing a semiconductor light-emitting element according to the first embodiment of the present invention. The semiconductor light-emitting element is cleaved so that the resonator length becomes 800 μm. The front end surface 10 of the semiconductor light-emitting element is subjected to low reflection coating of a reflectivity of 10%, and the rear end surface 12 of the semiconductor light-emitting element is subjected to high reflection coating of a reflectivity of 95%.

FIG. 2 is a sectional view of the semiconductor light-emitting element drawn along line A-A′ shown in FIG. 1. On a GaN substrate 14, an n-type AlGaN clad layer 18 having a thickness of 3.0 μm, an n-type GaN light guiding layer 20 having a thickness of 100 nm, an undoped InGaN light confinement layer 22 having a thickness of 7 nm, an active layer 24, an undoped InGaN light confinement layer 26 having a thickness of 7 nm, an undoped AlGaN intermediate layer 28 having a thickness of 30 nm, an undoped InGaN intermediate layer 30 having a thickness of 5 nm, a p-type AlGaN electron barrier layer 32 having a thickness of 10 nm, a p-type AlGaN clad layer 34 having a thickness of 450 nm, and a p-type GaN contact layer 36 having a thickness of 100 nm are sequentially formed as a semiconductor laminate structure 16.

Here, the relative proportion of Al in the n-type AlGaN clad layer 18 is 0.04. The active layer 24 has a multiple quantum well structure wherein three layers of undoped InGaN well layers each having a thickness of 3.5 nm and a relative proportion of In of 0.14, and two layers of undoped InGaN barrier layers each having a thickness of 7.0 nm and a relative proportion of In of 0.02 are alternately laminated. The relative proportion of In in each of the InGaN light confinement layers 22 and 26 is 0.02. The relative proportion of Al in the undoped AlGaN intermediate layer 28 is 0.03. The relative proportion of In in the undoped InGaN intermediate layer 30 is 0.02. The relative proportion of Al in the p-type AlGaN electron barrier layer 32 is 0.18. The relative proportion of Al in the p-type AlGaN clad layer 34 is 0.04.

The p-type AlGaN clad layer 34 and the p-type GaN contact layer 36 are etched to form a stripe-shaped waveguide region 38 on the upper surface of the semiconductor laminate structure 16 toward the <1-100> direction. The width and the height of the waveguide region 38 are 1.5 μm and 450 nm, respectively.

Recessed portions 40 are formed on the upper surface of the semiconductor laminate structure 16 separately from the waveguide region 38. The recessed portions 40 are formed on the right and left of the waveguide region 38 in the vicinity of the front end surface 10 of the resonator. The distance w between the side face of the recessed portions 40 close to the waveguide region 38 and the waveguide region 38 is 3.0 μm. The width of each recessed portion 40 in the direction parallel to the end surfaces of the resonator is 10 μm, and the width of each recessed portion 40 in the resonator direction is 10 μm. The depth of each recessed portion 40 is 2.5 μm. The planar shape of the recessed portion 40 is rectangular, the two sides of the rectangle are parallel to the end surfaces of the resonator, and the other two sides of the rectangle are parallel to the direction of the resonator.

The upper surface of the p-type AlGaN clad layer 34 in the region other than the waveguide region 38 and the side face of the waveguide region 38 are coated with a SiO₂ film 42 having a thickness of 200 nm. The side and bottom faces of each recessed portion 40 are coated with a SiO₂ film 44 having a thickness of 200 nm. An opening is formed in the SiO₂ film 42 on the waveguide region 38. Through the opening, the p-type electrode 46 is electrically connected to the p-type GaN contact layer 36. The p-type electrode 46 has a structure wherein a Pd film and an Au film are sequentially laminated. On the p-type electrode 46, a pad electrode 48 for wire bonding or solder bonding is formed. The pad electrode 48 has a structure wherein a Ti film, a Pt film, and an Au film are sequentially laminated. To the back face of the GaN substrate 14, an n-type electrode 50 wherein a Ti film, a Pt film, and an Au film are sequentially laminated is electrically connected.

As a characteristic of the first embodiment, an inner recessed portion electrode 52 is formed in each recessed portion 40 via the SiO₂ film 44. The inner recessed portion electrode 52 is a part of the pad electrode 48.

Next, the method for manufacturing a semiconductor light-emitting element according to the first embodiment will be described. First, on a GaN substrate 14 whose surface has been previously cleaned by thermal cleaning or the like, an n-type AIGaN clad layer 18, an n-type GaN light guiding layer 20, an undoped InGaN light confinement layer 22, an active layer 24, an undoped InGaN light confinement layer 26, an undoped AlGaN intermediate layer 28, an undoped InGaN intermediate layer 30, a p-type AlGaN electron barrier layer 32, a p-type AlGaN clad layer 34, and a p-type GaN contact layer 36 are sequentially formed by metal-organic chemical vapor deposition (MOCVD).

Here, the growing temperature for the n-type AIGaN clad layer 18 and the n-type GaN light guiding layer 20 is 1000° C., the growing temperature for the undoped InGaN light confinement layer 22 to the undoped InGaN light confinement layer 26 is 740° C., the growing temperature for the undoped AlGaN intermediate layer 28 is 1000° C., the growing temperature for the undoped InGaN intermediate layer 30 is 740° C., and the growing temperature for the p-type AlGaN electron barrier layer 32 to the p-type GaN contact layer 36 is 1000° C.

Next, a resist is applied onto the entire surface of the wafer that has been subjected to the above-described crystal growth, and a resist pattern having a shape corresponding to the shape of the waveguide region 38 is formed by lithography. The p-type AlGaN clad layer 34 is etched to the middle by, for example, RIE using the resist pattern as a mask to form the waveguide region 38. As an etching gas used in RIE, for example, a chlorine-based gas is used.

Next, leaving the resist pattern used as the mask, a SiO₂ film 42 is formed again on the entire surface of the substrate by, for example, CVD, vacuum deposition, and sputtering, and at the same time of removing the resist, the removal, known as liftoff, of the SiO₂ film 42 on the waveguide region 38 is performed.

Next, a Pd film and an Au film are sequentially formed by, for example, vacuum deposition, and liftoff is performed to form the p-type electrode 46.

Next, a resist pattern of a shape having openings at the locations of recessed portions 40 is formed by resist application and lithography, the SiO₂ film 42 is etched by wet etching or dry etching, and the semiconductor laminate structure 16 beneath the SiO₂ film 42 is etched by RIE or the like to form the recessed portion 40.

Next, a SiO₂ film 44 is formed by, for example, CVD, vacuum deposition, or sputtering, so as to coat the side and bottom faces of the recessed portion 40 for insulating the semiconductor laminate structure 16 exposed in the recessed portion 40. The shape of the SiO₂ film 44 can be optionally determined by liftoff using resist application and lithography.

Next, a Ti film, a Pt film, and an Au film are sequentially laminated on the entire surface of the substrate by, for example, vacuum deposition and a pad electrode 48 is formed by resist application, lithography and wet etching or dry etching. At this time, the pad electrode 48 is also formed in the recessed portion 40 via the SiO₂ film 44 to use the pad electrode 48 present in the recessed portion 40 as the inner recessed portion electrode 52.

Next, a Ti film, a Pt film, and an Au film are sequentially laminated on the back face of the GaN substrate 14 by vacuum vapor deposition to form an n-type electrode 50. Then, alloy treatment for ohmic contact is performed.

Next, the wafer is processed by cleaving or the like into bar shape to form the front end surface 10 and the rear end surface 12, and these end surfaces of the resonator are subjected to end-surface coating. Thereafter, the bar is separated into chips by cleaving or the like. Through the above-described processes, the semiconductor light-emitting element according to the first embodiment is manufactured.

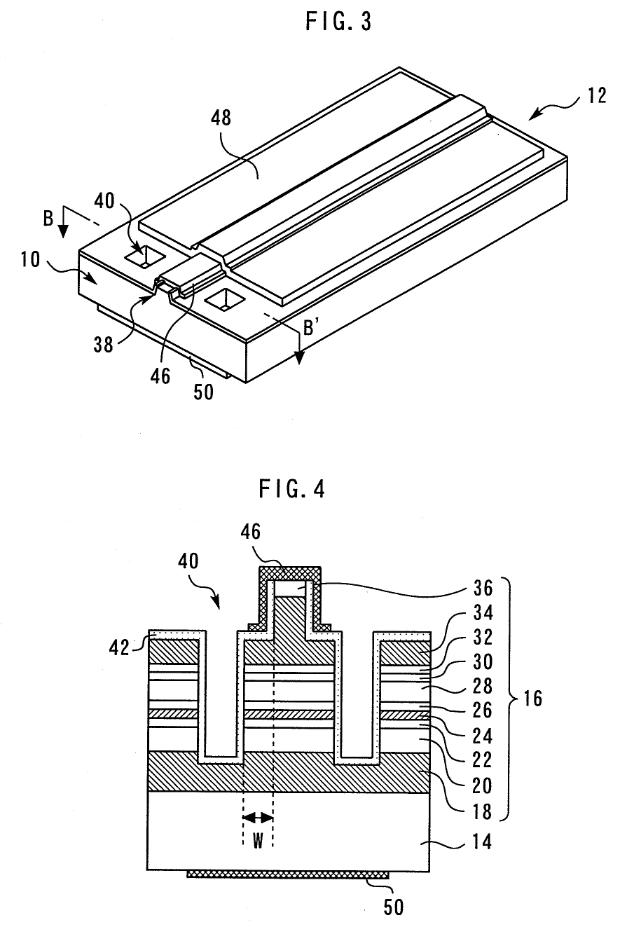

The effect of the semiconductor light-emitting element according to the first embodiment will be described comparing with comparative embodiments. FIG. 3 is a perspective view showing a semiconductor light-emitting element according to a comparative embodiment. FIG. 4 is a sectional view of the semiconductor light-emitting element along line B-B′ shown in FIG. 3. Although recessed portions 40 are formed in the semiconductor laminate structure 16 as in the first embodiment, no inner recessed portion electrodes 52 are formed in the recessed portions 40. Other configurations are identical to the configurations of the first embodiment.

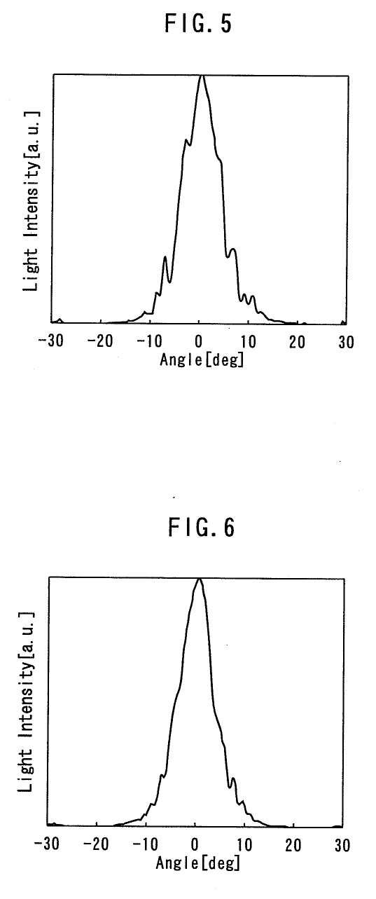

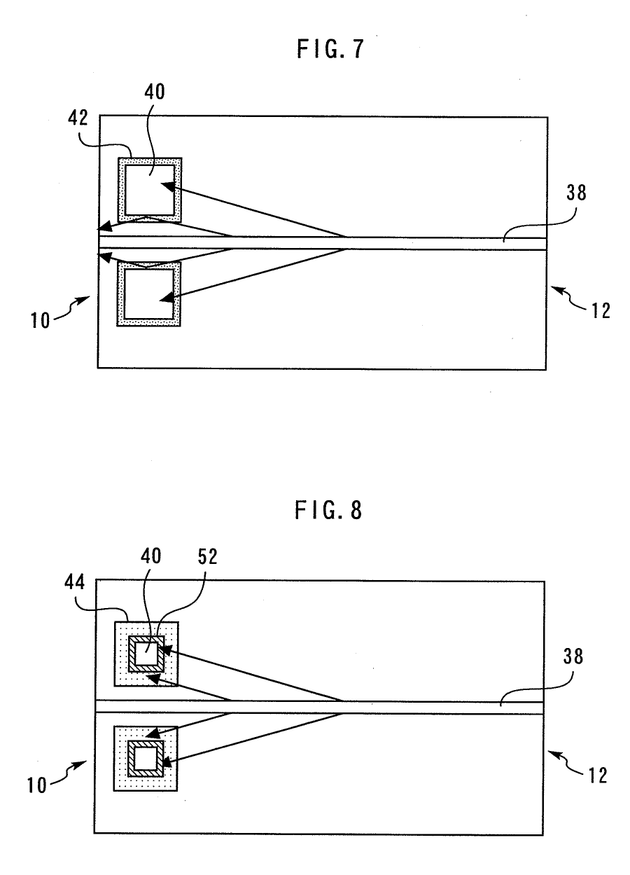

FIG. 5 is a graph showing a result of measurement of a semiconductor light-emitting element wherein no recessed portions are formed in the horizontal direction FFP. FIG. 6 is a graph showing a result of measurement of a semiconductor light-emitting element in the horizontal direction FFP according to the comparative embodiment. As a result, it was known that ripples were reduced in the comparative embodiment having the recessed portion 40 compared with the case having no recessed portion. However, even the semiconductor light-emitting element having recessed portions, ripples remained in FFP, and the ripples of FFP could not be sufficiently suppressed. As shown in FIG. 7, which is a top view of the comparative embodiment, this is because scattered light passes between the waveguide region 38 and the recessed portion 40, and guided to the front end surface 10 side, or guided or transmitted in the substrate side from the recessed portion 40.

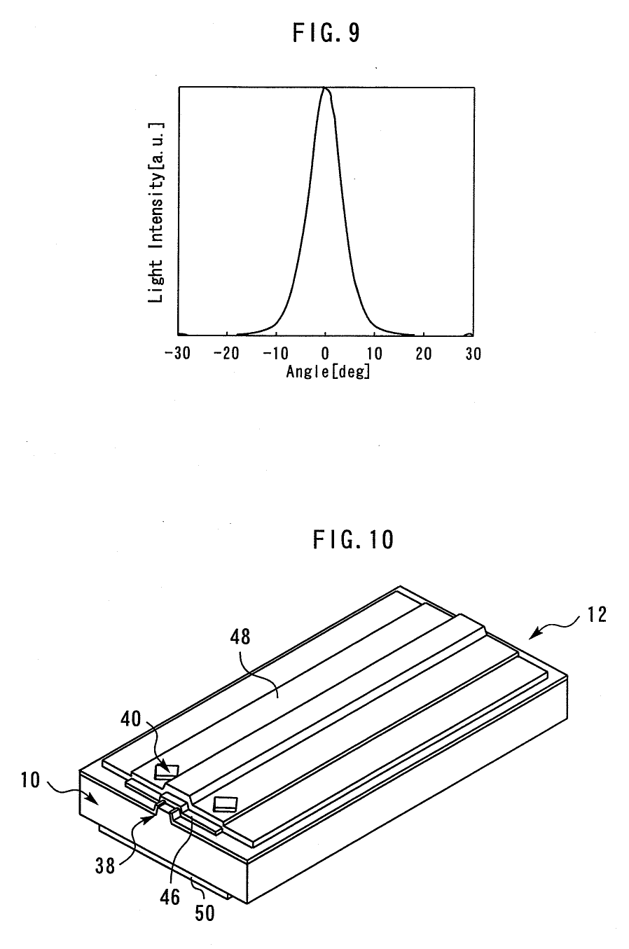

In order to prevent this phenomenon, the distance between the waveguide region 38 and the recessed portion 40 is shortened. However, if this distance is excessively short, the principal mode of laser beams leaches to the side of the recessed portion 40. Therefore, since the effect of reflection or scattering at the side of the recessed portion 40 is large, the turbulence of FFP is rather increased.

Whereas, in the first embodiment, the inner recessed portion electrodes 52 is formed in the recessed portion 40 of the semiconductor laminate structure 16. FIG. 8 is a top view showing a semiconductor light-emitting element according to the first embodiment. FIG. 9 is a graph showing a result of measurement of FFP in the horizontal direction of a semiconductor light-emitting element according to the first embodiment. In the case of the first embodiment, as shown in FIG. 8, since almost all of light scattered in the horizontal direction is absorbed by the inner recessed portion electrodes 52 in the side or bottom faces of the recessed portions 40, no scattered light is radiated from the end surface. Therefore, as shown in FIG. 9, the ripples of FFP can be sufficiently suppressed.

Also in the first embodiment, although the inner recessed portion electrodes 52 formed in the recessed portions 40 are a part of the pad electrode 48, they can also be a part of at least one of the p-type electrode 46 and the pad electrode 48. Therefore, the inner recessed portion electrodes 52 can be formed at the same time as at least one of the p-type electrode 46 and the pad electrode 48. Thereby, the inner recessed portion electrodes 52 can be formed without increasing the number of process steps. When the p-type electrodes 46 are formed in the recessed portions 40, the p-type electrodes 46 must be formed after the recessed portions 40 have been formed.

The locations of the recessed portions 40 in the resonator direction are optional. However, since the radiated light generated in the front end surface 10 side from the recessed portions 40 is not absorbed in the recessed portions 40, the recessed portions 40 are preferably formed in the vicinity of the front end surface 10. The recessed portions 40 may be formed in the vicinity of the rear end surface 12.

When the semiconductor substrate and the semiconductor laminate structure are formed of a nitride-based III-V group compound semiconductor, since ripples are often generated in the FFP in the horizontal direction, the first embodiment is particularly effective.

In order to enhance the effect of light absorbing in the recessed portions 40, the depth of the recessed portions 40 is preferably elongated to the vicinity or the lower portion of the active layer 24 where the photoelectric field intensity is highest in the vertical direction.

Since metals have generally very large light absorption coefficients, a sufficient effect can be obtained even if the length the recessed portions 40 in the resonator direction is not so large. Therefore, it is sufficient that the length the recessed portions 40 in the resonator direction is 0.5 μm or more.

### Second Embodiment

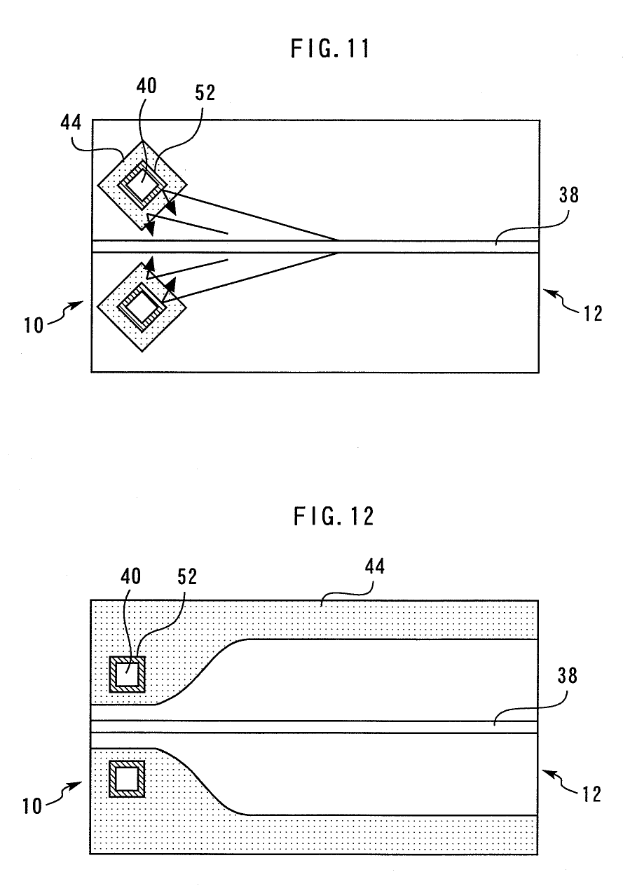

FIG. 10 is a perspective view showing a semiconductor light-emitting element according to the second embodiment. FIG. 11 is a top view showing a semiconductor light-emitting element according to the second embodiment. In the semiconductor light-emitting element, the rectangles, which are the planer shapes of the recessed portions 40, are rotated by 45° from those in the first embodiment. Specifically, each side of the rectangles in the recessed portions 40 is diagonal to the end surfaces of the resonator and the resonator direction. Other configuration and manufacturing method are identical to those in the first embodiment. Thereby, the reflection of only a small part of radiation light reflected by the recessed portions 40 to the direction of the front end surface 10 again can be suppressed.

### Third Embodiment

FIG. 12 is a top view showing a semiconductor light-emitting element according to the third embodiment. The insulating film 44 is also formed in the region on the semiconductor laminate structure 16 in the exterior of the recessed portions 40. However, to electrically connect the p-type electrode 46 to the p-type GaN contact layer 36 in the waveguide region 38, the insulating film 44 is not formed in the waveguide region 38. To insulate the semiconductor layer from the inner recessed portion electrode 52, the insulating film 44 must be formed also in the recessed portions 40. Therefore, the distance between the insulating film 44 and the waveguide region 38 is narrowed in the region where the recessed portions 40 are present on the semiconductor laminate structure 16.

The stress of the insulating film 44 is applied to crystals in the interface between the region where the insulating film 44 is present and the region where the insulating film 44 is absent, and varies the refractive index of the crystals. If the stress is uneven in the resonator direction, since the refractive index sensed by laser beams becomes uneven in the resonator direction, light is scattered, and the disturbance of FFP occurs in the horizontal direction. To prevent this as much as possible, it is effective to widen the opening width of the insulating film. In the third embodiment, therefore, the distance between the insulating film 44 and the waveguide region 38 is widened in the region where the recessed portions 40 are absent compared with the region where the recessed portions 40 are present. However, if the distance is rapidly changed in the connected part between both regions, since the above-described stress is rapidly changed, it is preferable that the distance is slowly changed.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2009-028406, filed on Feb. 10, 2009 including specification, claims, drawings and summary, on which the Convention priority of the present application is based, are incorporated herein by reference in its entirety.

1. A semiconductor light-emitting element comprising:
a semiconductor substrate;
a semiconductor laminate structure having a first conductivity-type cladding layer, an active layer, a second conductivity-type cladding layer, and a second conductivity-type contact layer sequentially arranged on said semiconductor substrate, said semiconductor laminate structure including a stripe-shaped waveguide region on an upper surface of said semiconductor laminate structure, and recessed portions on the upper surface and spaced from said waveguide region;
a first electrode electrically connected to said semiconductor substrate;
a second electrode electrically connected to said contact layer;
a pad electrode on said second electrode;
an insulating film; and
an inner recessed portion electrode located in said recessed portion with said insulating film interposed between said inner recess portion electrode and said recessed portion.

2. The semiconductor light-emitting element according to claim 1, wherein said inner recessed portion electrode is a part of at least one of said second electrode, and said pad electrode.

3. The semiconductor light-emitting element according to claim 1, wherein said recessed portion has a rectangular shape, in a plane, and two sides of the rectangle are parallel to an end surface of a resonator of said light-emitting element, and two sides of the rectangle are parallel to said resonator.

4. The semiconductor light-emitting element according to claim 1, wherein said recessed portion has a rectangular shape, in a plane, and each side of the rectangle is oblique to an end surface of a resonator of said light-emitting element and to said resonator.

5. The semiconductor light-emitting element according to claim 1, wherein
said insulating film is located in regions other than said waveguide region on said semiconductor laminate structure outside of said recessed portion; and
distance between said insulating film and said waveguide region is wider where said recessed portion is absent than in the region where said recessed portion is present.

6. The semiconductor light-emitting element according to claim 1, wherein said recessed portion is located in the vicinity of one of a front end surface and a rear end surface of a resonator of said light-emitting element.

7. The semiconductor light-emitting element according to claim 1, wherein said semiconductor substrate and said semiconductor laminate structure include a nitride-based III-V compound semiconductor.

8. A method for manufacturing the semiconductor light-emitting element according to claim 1, including forming said inner recessed portion electrode and at least one of said second electrode and said pad electrode simultaneously.
